(19) United States
(12) Patent Application Publication
(10) Pub. No.: US 2021/0384517 A1
(43) Pub. Date: Dec. 9, 2021

(54) ALL-SOLID-STATE BATTERY HAVING HIGH ENERGY DENSITY AND CAPABLE OF STABLE OPERATION

(71) Applicants: Hyundai Motor Company, Seoul (KR); Kia Motors Corporation, Seoul (KR)

(72) Inventors: Tae Young Kwon, Daegu (KR); Jae Min Lim, Suwon (KR); Hoon Seok, Suwon (KR); Sang Heon Lee, Yongin (KR); Sang Mo Kim, Hwaseong (KR)

(21) Appl. No.: 17/095,456

(22) Filed: Nov. 11, 2020

(30) Foreign Application Priority Data
Jun. 9, 2020 (KR) 10-2020-0069341

(51) Int. Cl. H01M 4/80; H01M 4/587; H01M 10/0562; H01M 10/0585; H01M 4/38; H01M 4/36; H01M 10/0525; H01M 4/66

(52) U.S. Cl. CPC H01M 4/80; H01M 4/587; H01M 10/0562; H01M 10/0585; H01M 4/382; H01M 2004/021; H01M 10/0525; H01M 4/663; H01M 4/667; H01M 2220/20; H01M 4/364

(57) ABSTRACT

Disclosed is an anodeless-type all-solid-state battery having a novel structure, which has high energy density and is capable of operating stably.

### CROSS REFERENCE TO RELATED APPLICATION

The present application claims priority based on Korean Patent Application No. 10-2020-0069341, filed on Jun. 9, 2020, the entire content of which is incorporated herein for all purposes by this reference.

### TECHNICAL FIELD

The present invention relates to an anodeless-type all-solid-state battery having a novel structure, which has high energy density and is capable of operating stably.

### BACKGROUND

Rechargeable secondary batteries have been used not only for small-sized electronic devices such as mobile phones, laptop computers and the like but also for large-sized transport vehicles such as hybrid vehicles, electric vehicles and the like. Accordingly, there is a need to develop secondary batteries having higher stability and energy density.

Conventional secondary batteries are mostly configured such that cells are formed using an organic solvent (organic liquid electrolyte), and thus limitations are imposed on the extent to which the stability and energy density thereof may be improved.

Meanwhile, an all-solid-state battery using an inorganic solid electrolyte without using an organic solvent has been receiving a great attention these days and thus a cell may be manufactured in a safer and simpler manner.

However, the all-solid-state battery is problematic in that the energy density and power output performance thereof are inferior to those of conventional lithium-ion batteries using a liquid electrolyte. With the goal of solving the above problem, thorough research into improving the electrodes of all-solid-state batteries is ongoing.

In particular, the anode for an all-solid-state battery is mostly formed of graphite. In this case, in order to ensure ionic conductivity, an excess of a solid electrolyte, having a large specific gravity, is added along with the graphite, and thus the energy density per unit weight is very low compared to lithium-ion batteries. Moreover, when lithium metal is used for the anode, there are technical limitations in terms of price competitiveness and large-scale implementation.

Thorough research is currently ongoing into all-solid-state batteries having high energy density, one of which is an anodeless-type all-solid-state battery. The anodeless-type all-solid-state battery is a battery in which lithium is precipitated on an anode current collector instead of using an anode active material such as graphite or lithium metal.

The anodeless-type all-solid-state battery may theoretically achieve a high energy density, but may cause problems such as the risk of short circuits due to uneven precipitation of lithium and deterioration of battery performance due to an increase in irreversible reactions.

### SUMMARY

In preferred aspects, provided is an anodeless-type all-solid-state battery that has high energy density and is capable of stable operation.

The term “anodeless-type all-solid-state battery” as used herein refers to an all-solid state battery that lacks a compatible, parallel and/or structural similar looking component of the counter electrode of a cathode, i.e. anode. Rather the anodeless-type all-solid battery may include a functional component that similarly or equivalently serves as a conventional anode. In certain embodiments, the anode current collector layer may be used as the counter electrode of the cathode in the anodeless-type all-solid battery without including an anode layer (e.g., lacking anode active material layer or lithium layer) and form non-matching or non-symmetric structure to the cathode.

The objectives of the present invention are not limited to the foregoing, and will be able to be clearly understood through the following description and to be realized by the means described in the claims and combinations thereof.

In an aspect, provided is an all-solid-state battery including an anode current collector layer, a porous layer disposed on the anode current collector layer and having a porous structure including a fibrous material, an electrolyte layer disposed on the porous layer, and a composite cathode layer disposed on the electrolyte layer, in which at least a portion of the surface of the fibrous material is coated with a solid electrolyte.

Preferably, the fibrous material is interconnected in three dimensions, for example, to form a network structure.

The “porous structure” as used herein refers to a porous material that is formed in a certain shape and includes plurality of shapes of pores (e.g., circular, or non-circular), holes, cavity (e.g., microcavity), labyrinth, channel or the like, whether formed uniformly or without regularity. Exemplary porous structure may include pores (e.g., closed or open pores) within a predetermined size within a range from sub-micrometer to micrometer size, which is measured by maximum diameter of the pores.

The fibrous material may suitably include one or more selected from the group consisting of carbon nanofiber, carbon nanotubes, and vapor-grown carbon fiber, or other suitable material.

The solid electrolyte may suitably have a thickness of about 0.1 μm to 20 μm.

The solid electrolyte may suitably include a sulfide solid electrolyte.

The porous layer may suitably have a thickness of about 100 μm to 500 μm.

The porous layer may suitably have a porosity of about 10% to 80%.

The porous layer may include a first region ranging to a predetermined depth from one surface of the anode current collector layer, and a second region, which is a remaining portion other than the first region.

In the all-solid-state battery, the amount of the solid electrolyte applied on the first region may be less than the amount of the solid electrolyte applied on the second region.

In the all-solid-state battery, the lithium ionic conductivity of the solid electrolyte of the first region may be greater than the lithium ionic conductivity of the solid electrolyte of the second region.

In the all-solid-state battery, the electronic conductivity of the fibrous material of the first region may be greater than the electronic conductivity of the fibrous material of the second region.

The first region may include metal particles forming an alloy with lithium.

The metal particles may include one or more selected from the group consisting of lithium (Li), indium (In), gold (Au), bismuth (Bi), zinc (Zn), aluminum (Al), iron (Fe), tin (Sn), and titanium (Ti).

Also provided herein is a vehicle including the all-solid-state battery described herein.

According to various embodiments of the present invention, an all-solid-state battery having greatly increased energy density can be obtained because a cell can be manufactured in the form of a thin film compared to conventional all-solid-state batteries.

Further, since lithium is stably precipitated in the porous layer, the formation of lithium dendrites and/or dead lithium can be suppressed, and thus, the all-solid-state battery can operate stably.

The effects of the present invention are not limited to the foregoing, and should be understood to include all effects that can be reasonably anticipated from the following description.

Other aspects of the invention are disclosed infra.

### BRIEF DESCRIPTION OF DRAWINGS

FIG. 1 shows an exemplary all-solid-state battery according to an exemplary embodiment of the present invention;

FIG. 2 shows exemplary internal pore structure of an exemplary porous layer of an exemplary all-solid-state battery according to an exemplary embodiment of the present invention;

FIG. 3 is a reference view showing an exemplary porous layer of exemplary all-solid-state battery according to an exemplary embodiment of the present invention;

FIG. 4 is a reference view showing an exemplary porous layer of an exemplary all-solid-state battery according to an exemplary embodiment of the present invention;

FIGS. 5A and 5B show the results of analysis of exemplary porous layers of Example according to an exemplary embodiment of the present invention and Comparative Example 1 using an optical microscope; and

FIG. 6 shows the results of evaluation of durability of exemplary all-solid-state batteries of Example according to an exemplary embodiment of the present invention and Comparative Examples 1 and 2.

### DETAILED DESCRIPTION

The above and other objectives, features and advantages of the present invention will be more clearly understood from the following preferred embodiments taken in conjunction with the accompanying drawings. However, the present invention is not limited to the embodiments disclosed herein, and may be modified into different forms. These embodiments are provided to thoroughly explain the invention and to sufficiently transfer the spirit of the present invention to those skilled in the art.

Throughout the drawings, the same reference numerals will refer to the same or like elements. For the sake of clarity of the present invention, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present invention. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting the measurements that essentially occur in obtaining these values, among others, and thus should be understood to be modified by the term “about” in all cases.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

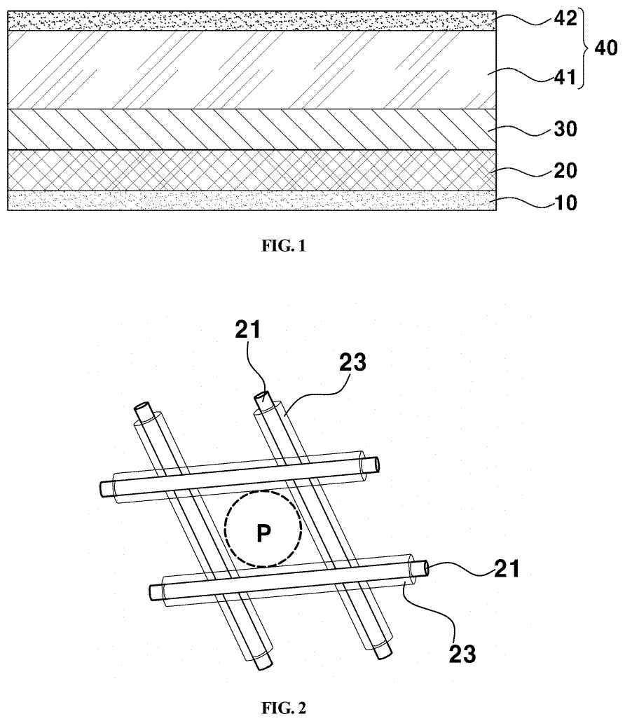

FIG. 1 shows an exemplary all-solid-state battery according to an exemplary embodiment of the present invention.

FIG. 2 shows the internal pore structure of an exemplary porous layer of an exemplary all-solid-state battery according to an exemplary embodiment of the present invention.

As shown in FIGS. 1 and 2, the all-solid-state battery 1 includes an anode current collector layer 10, a porous layer 20 disposed on the anode current collector layer 10 and having a porous structure including a fibrous material 21 that is interconnected in three dimensions, an electrolyte layer 30 disposed on the porous layer 20, and a composite cathode layer 40 disposed on the electrolyte layer 30.

As shown in FIG. 2, at least a portion of the surface of the fibrous material 21 may be coated with a solid electrolyte 23.

The anode current collector layer 10 may be a kind of sheet-like or planar substrate.

The anode current collector layer 10 may be a metal thin film including a metal component selected from the group consisting of copper (Cu), nickel (Ni) and combinations thereof. Particularly, the anode current collector layer 10 may be a high-density metal thin film having a porosity of less than about 1%.

The anode current collector layer 10 may have a thickness of about 1 μm to 20 μm, and particularly about 5 μm to 15 μm.

The porous layer 20 is a layer that includes therein pores P, which serve as spaces for storing lithium that is precipitated during charging of the all-solid-state battery 1, and the pores P may be formed by a network in which a fibrous material 21 is interconnected in three dimensions.

The fibrous material 21 is configured to provide a path for movement of electrons within the porous layer 20.

The fibrous material 21 may include one or more selected from the group consisting of carbon nanofiber, carbon nanotubes, and vapor-grown carbon fiber.

The diameter, length and the like of the fibrous material 21 are not particularly limited, and any fibrous material may be used, so long as the fibrous material 21 is interconnected to form a network as shown in FIG. 2.

At least a portion of the surface of the fibrous material 21 may be coated with the solid electrolyte 23.

The solid electrolyte 23 is configured to provide a path for movement of lithium ions within the porous layer 20.

The solid electrolyte 23 may be applied to a thickness of 0.1 μm to 20 μm. When the thickness thereof is less than about 0.1 μm, the ability thereof to transport lithium ions may be reduced. On the other hand, when the thickness thereof is greater than about 20 μm, problems related to the movement of electrons or insufficient pores for lithium ions to precipitate may occur.

The solid electrolyte 23 may include a sulfide solid electrolyte. The sulfide solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O-LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, and the like.

Also, the sulfide solid electrolyte may be an amorphous or crystalline solid electrolyte. In particular, when the sulfide solid electrolyte is a crystalline solid electrolyte, it may have a cubic or argyrodite crystal structure.

The lithium ionic conductivity of the solid electrolyte 23 is not particularly limited, and may be, for example, about 1×10⁻⁴ S/cm or greater.

Also, the diameter D50 of the solid electrolyte 23 is not particularly limited, and may be, for example, about 0.1 μm to 10 μm. Here, the diameter of the solid electrolyte 23 is the diameter of a solid electrolyte in a powder state before coating, rather than the state of being applied on the fibrous material 21.

The porous layer 20 may have a thickness of about 100 μm to 500 μm and a porosity of about 10% to 80%. When the thickness and porosity of the porous layer 20 fall in the above ranges, the energy density of the all-solid-state battery may be greatly increased.

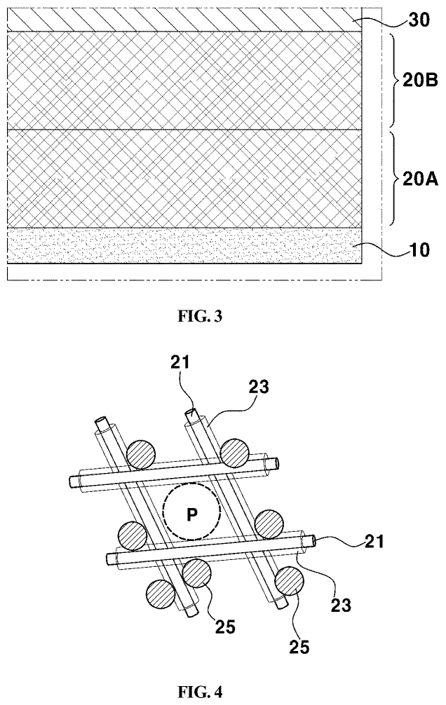

FIG. 3 is a reference view showing the porous layer 20 according to various exemplary embodiments of the present invention. With reference thereto, the porous layer 20 may include a first region 20A ranging to a predetermined depth from one surface of the anode current collector layer 10, and a second region 20B, which is a remaining portion other than the first region 20A.

The depth of the first region 20A is not particularly limited, but may be, for example, about 10% to 50% of the total thickness of the porous layer 20.

The porous layer 20 may be characterized in that the amount of the solid electrolyte 23 applied on the first region 20A is less than the amount of the solid electrolyte 23 applied on the second region 20B.

The second region 20B may be coated with the solid electrolyte 23 at a high concentration, thus inhibiting the movement of electrons in the second region 20B. Accordingly, lithium ions and electrons may more actively bind to each other in the first region 20A, in which it is relatively easy to move electrons. As a result, lithium precipitates from the pores close to the anode current collector layer 10. Since the lithium comes into close contact with the anode current collector layer 10, when the all-solid-state battery 1 is discharged, the lithium may be more easily converted into lithium ions, thereby increasing charging and discharging efficiency.

Alternatively, the porous layer 20 may be characterized in that the lithium ionic conductivity of the solid electrolyte of the first region 20A is greater than the lithium ionic conductivity of the solid electrolyte of the second region 20B.

The method of varying the lithium ionic conductivity of the solid electrolyte included in the first region 20A and the second region 20B is not particularly limited. For example, different types of solid electrolytes or solid electrolytes having different crystallinities may be used in respective regions.

Preferably, the lithium ionic conductivity in the first region 20A, which is in contact with the anode current collector layer 10, may be increased. Accordingly, in the first region 20A, in which the movement of lithium ions is relatively fast, the binding of lithium ions and electrons may occur more actively. As a result, lithium precipitates from the pores close to the anode current collector layer 10. Since the lithium comes into close contact with the anode current collector layer 10, when the all-solid-state battery 1 is discharged, the lithium may be more easily converted into lithium ions, thereby increasing charging and discharging efficiency.

Moreover, the porous layer 20 may be characterized in that the electronic conductivity of the fibrous material 21 of the first region 20A is greater than the electronic conductivity of the fibrous material 21 of the second region 20B.

Preferably, relative movement of electrons in the first region 20A may be facilitated as described above. Therefore, the binding of lithium ions and electrons may occur more actively in the first region 20A. As a result, lithium may precipitate from the pores close to the anode current collector layer 10. Since the lithium comes into close contact with the anode current collector layer 10, when the all-solid-state battery 1 is discharged, the lithium may be more easily converted into lithium ions, thereby increasing charging and discharging efficiency.

FIG. 4 is a reference view showing an exemplary porous layer 20 according to an exemplary embodiment of the present invention. Particularly, FIG. 4 shows the internal pore structure of the first region 20A.

With reference thereto, the first region 20A may include metal particles 25 forming an alloy with lithium.

The metal particles 25 are configured to serve as a kind of seed for lithium ions moving to the porous layer 20 when charging the all-solid-state battery 1. For example, as the all-solid-state battery 1 is charged, the lithium ions may mainly grow to lithium around the metal particles 25.

The metal particles 25 may include one or more selected from the group consisting of lithium (Li), indium (In), gold (Au), bismuth (Bi), zinc (Zn), aluminum (Al), iron (Fe), tin (Sn), and titanium (Ti).

The electrolyte layer 30 is interposed between the porous layer 20 and the composite cathode layer 40 so that lithium ions may move between the two layers.

The solid electrolyte layer 30 may include an oxide solid electrolyte or a sulfide solid electrolyte. Here, the use of a sulfide solid electrolyte having high lithium ionic conductivity is preferable. The sulfide solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅-Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, and the like.

The composite cathode layer 40 may include a cathode active material layer 41 provided on the electrolyte layer 30 and a cathode current collector layer 42 provided on the cathode active material layer 41.

The cathode active material layer 41 may include a cathode active material, a solid electrolyte, a conductive material, a binder, etc.

The cathode active material may be an oxide active material or a sulfide active material.

The oxide active material may be a rock-salt-layer-type active material such as LiCoO₂, LiMnO₂, LiNiO₂, LiVO₂, Li₁₊ₓNi_{1/3}Co_{1/3}Mn_{1/3}O₂ or the like, a spinel-type active material such as LiMn₂O₄, Li(Ni_{0.5}Mn_{1.5})O₄ or the like, an inverse-spinel-type active material such as LiNiVO₄, LiCoVO₄ or the like, an olivine-type active material such as LiFePO₄, LiMnPO₄, LiCoPO₄, LiNiPO₄ or the like, a silicon-containing active material such as Li₂FeSiO₄, Li₂MnSiO₄ or the like, a rock-salt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (M being at least one of Al, Mg, Co, Fe, Ni and Zn, 0<x+y<2), or lithium titanate such as Li₄Ti₅O₁₂ or the like.

The sulfide active material may suitably include copper chevrel, iron sulfide, cobalt sulfide, nickel sulfide, and the like.

The solid electrolyte may be an oxide solid electrolyte or a sulfide solid electrolyte. Here, the use of a sulfide solid electrolyte having high lithium ionic conductivity is preferable. The sulfide solid electrolyte is not particularly limited, but may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZₘSₙ (in which m and n are positive numbers, and Z is any one of Ge, Zn and Ga), Li₂S—GeS₂, Li₂S—SiS₂—Li₃PO₄, Li₂S—SiS₂—LiₓMO_{y} (in which x and y are positive numbers, and M is any one of P, Si, Ge, B, Al, Ga and In), Li₁₀GeP₂S₁₂, and the like. The solid electrolyte may be the same as or different from the solid electrolyte included in the solid electrolyte layer 30.

The conductive material may suitably include carbon black, conductive graphite, ethylene black, graphene, and the like.

The binder may suitably include BR (butadiene rubber), NBR (nitrile butadiene rubber), HNBR (hydrogenated nitrile butadiene rubber), PVDF (polyvinylidene difluoride), PTFE (polytetrafluoroethylene), CMC (carboxymethylcellulose), and the like, and may be the same as or different from the binder included in the porous layer 20.

The cathode current collector layer 42 may be an aluminum foil or the like.

A better understanding of the present invention will be given through the following examples, which are merely set forth to illustrate the present invention but are not to be construed as limiting the scope of the present invention.

### EXAMPLE

### Example

First, a porous layer was manufactured. A layer in which carbon nanofiber, serving as a fibrous material, was interconnected in three dimensions was prepared. The thickness of the layer was about 350 μm, and the porosity thereof was about 80%. The layer was impregnated with a slurry including a solid electrolyte to afford a porous layer in which at least a portion of the surface of the fibrous material was coated with the solid electrolyte. Here, Li₆PS₅Cl was used as the solid electrolyte, and was added to a non-polar solvent along with butadiene rubber, serving as a binder, thus preparing the above slurry. Based on the results of observation with an optical microscope, the coating thickness of the solid electrolyte was about 10 μm. Also, the porosity of the porous layer was about 60%.

The porous layer and an anode current collector layer were joined to each other, and an electrolyte layer and a composite cathode layer were laminated on the porous layer, thus manufacturing an all-solid-state battery. The anode current collector layer, the electrolyte layer, and the composite cathode layer that were used were those typically useful in the art to which the present invention belongs.

### Comparative Example 1

An all-solid-state battery was manufactured in the same manner as in Example, with the exception that a porous layer was formed without coating the fibrous material with the solid electrolyte.

### Comparative Example 2

An all-solid-state battery was manufactured in the same manner as in Example, with the exception that a porous layer was obtained by adding carbon nanotubes and vapor-grown carbon fiber as additives, without coating the fibrous material with the solid electrolyte.

### Test Example 1—Results of Analysis with Optical Microscope (OM)

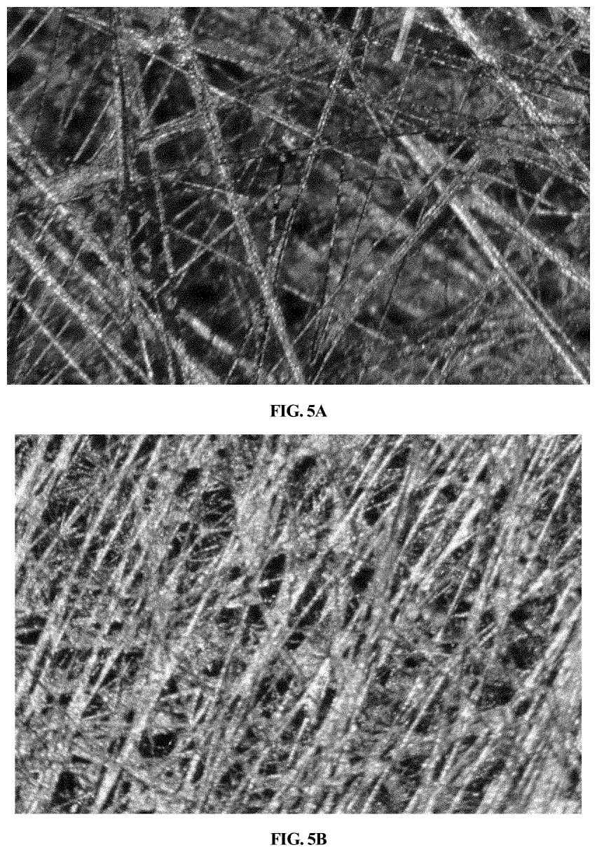

FIGS. 5A and 5B show the results of analysis of the porous layers of Example and Comparative Example 1 using an optical microscope. In particular, the porous layer of Example was configured such that the surface of the fibrous material was coated with the solid electrolyte, unlike Comparative Example 1.

### Test Example 2—Evaluation of Durability of All-Solid-State Battery

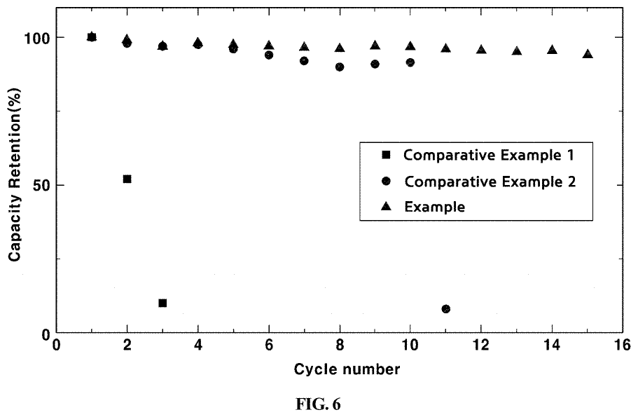

The durability of the all-solid-state batteries of Example and Comparative Examples 1 and 2 was evaluated at 0.1 C and at a temperature of 70° C. The results thereof are shown in FIG. 6. In particular, the capacity retention of the all-solid-state battery of Example was 90% or greater compared to the initial capacity until about 16 cycles, but the capacity retention was drastically decreased in 3 cycles in Comparative Example 1, and did not exceed 11 cycles in Comparative Example 2.

As described hereinbefore, the present invention has been described in detail with respect to test examples and exemplary embodiments. However, the scope of the present invention is not limited to the aforementioned test examples and examples, and various modifications and improved modes of the present invention using the basic concept of the present invention defined in the accompanying claims are also incorporated in the scope of the present invention.

What is claimed is:

1. An all-solid-state battery, comprising:
an anode current collector layer;
a porous layer disposed on the anode current collector layer and having a porous structure including a fibrous material;
an electrolyte layer disposed on the porous layer; and
a composite cathode layer disposed on the electrolyte layer,
wherein at least a portion of a surface of the fibrous material is coated with a solid electrolyte.

2. The all-solid-state battery of claim 1, wherein the fibrous material is interconnected in three dimensions.

3. The all-solid-state battery of claim 1, wherein the fibrous material comprises one or more selected from the group consisting of carbon nanofiber, carbon nanotubes, and vapor-grown carbon fiber.

4. The all-solid-state battery of claim 1, wherein the solid electrolyte has a thickness of about 0.1 μm to 20 μm.

5. The all-solid-state battery of claim 1, wherein the solid electrolyte comprises a sulfide solid electrolyte.

6. The all-solid-state battery of claim 1, wherein the porous layer has a thickness of about 100 μm to 500 μm.

7. The all-solid-state battery of claim 1, wherein the porous layer has a porosity of about 10% to 80%.

8. The all-solid-state battery of claim 1, wherein the porous layer comprises a first region, ranging to a predetermined depth from one surface of the anode current collector layer, and a second region, which is a remaining portion other than the first region.

9. The all-solid-state battery of claim 8, wherein an amount of the solid electrolyte applied on the first region is less than an amount of the solid electrolyte applied on the second region.

10. The all-solid-state battery of claim 8, wherein a lithium ionic conductivity of the solid electrolyte of the first region is greater than a lithium ionic conductivity of the solid electrolyte of the second region.

11. The all-solid-state battery of claim 8, wherein an electronic conductivity of the fibrous material of the first region is greater than an electronic conductivity of the fibrous material of the second region.

12. The all-solid-state battery of claim 8, wherein the first region comprises metal particles forming an alloy with lithium.

13. The all-solid-state battery of claim 12, wherein the metal particles comprise one or more selected from the group consisting of lithium (Li), indium (In), gold (Au), bismuth (Bi), zinc (Zn), aluminum (Al), iron (Fe), tin (Sn), and titanium (Ti).

14. A vehicle comprising an all-solid battery of claim 1.
